(19) United States
(12) Patent Application Publication
(10) Pub. No.: US 2007/0162165 A1
(43) Pub. Date: Jul. 12, 2007

(54) SYSTEM AND METHOD FOR USING WEB SYNDICATION PROTOCOLS AS AN OUT-OF-BAND UPnP SERVICE DISCOVERY SYSTEM

(75) Inventors: Vlad Stirbu, Tampere (FI); Petros Belimpasakis, Tampere (FI)

Correspondence Address: FOLEY & LARDNER LLP, P.O. BOX 80278, SAN DIEGO, CA, 92138-0278, US

(73) Assignee: Nokia Corporation

(21) Appl. No.: 11/566,132

(22) Filed: Dec. 1, 2006

Related U.S. Application Data
(60) Provisional application No. 60/742,181, filed on Dec. 2, 2005.

(51) Int. Cl. G05B 19/18

(52) U.S. Cl. 700/65

(57) ABSTRACT

An architecture where Web Syndication mechanisms such as RSS/Atom feeds can be used to discover remote UPnP devices for environments where the standard UPnP discovery mechanism (e.g. SSDP) does not work due to bearer-induced limitations or policy restrictions along the path. The present invention can be used to enable remote access to UPnP Networks. The present invention allows for the extension of usage of UPnP protocols and services beyond the physical boundaries of the home network. The present invention does not involve the use of multicast messages, which are problematic over uncontrolled networks such as the Internet. The present invention also has a low level of complexity; as SSDP is the only portion of the UPnP stack is altered.

### CROSS-REFERENCE TO RELATED PATENT APPLICATIONS

This application claims priority from Provisional Application U.S. Application No. 60/742,181, filed Dec. 2, 2005, incorporated herein by reference in its entirety.

### FIELD OF THE INVENTION

The present invention relates generally to Universal Plug and Play (UPnP) service discovery systems. More particularly, the present invention relates to the use of web syndication protocols to discover remote UPnP devices.

### BACKGROUND OF THE INVENTION

UPnP technology defines an architecture for pervasive peer-to-peer network connectivity of intelligent appliances, wireless devices, and personal computer devices of all types. UPnP is designed to bring easy-to-use, flexible, standards-based connectivity to ad-hoc or unmanaged networks whether in the home, in a small business, public spaces, or attached to the Internet. UPnP technology provides a distributed, open networking architecture that leverages TCP/IP and Web technologies in order to enable seamless proximity networking, in addition to control and data transfer among networked devices.

The UPnP Device Architecture (UDA) is designed to support zero-configuration, “invisible” networking and automatic discovery for a breadth of device categories from a wide range of vendors. In other words, UDA enables a device to be capable of dynamically joining a network, obtaining an IP address, conveying the device's capabilities, and learning about the presence and capabilities of other devices.

Web syndication is a form of syndication in which information from a website is made available for other sites or clients to use. Web syndication commonly refers to making Web feeds available from a site so that other visitors can obtain an updating list of content from it (for example, a person's latest blog postings, etc.). Web syndication originated with news and blog sites, but it is being increasingly used to syndicate virtually any type of information.

RSS is a family of XML file formats for web syndication that is used by news websites, weblogs and a wide variety of other entities. The technology behind RSS allows a person to subscribe to websites that have provided RSS feeds. Such sites are typically sites that change or add content regularly. To use this technology, one needs to set up an aggregation service. Once an aggregation service is established, one then has to subscribe to the sites from which updates are desired. The RSS formats provide web content or summaries of web content, together with links to the full versions of the content and other meta-data. This information is delivered as an XML file.

Atom is an XML-based document format for the syndication of web content, as well as an HTTP-based protocol for editing weblogs based on the format. Atom is a newer and more advanced protocol than RSS. Apart from the basic web syndication and feeds that are also provided by RSS, Atom supports more standardized meta-data information, along with the ability to make posts from an Atom client to an Atom server. This is in contrast to RSS, which only allows the client to obtain information from a server and not to post information.

The UDA describes the steps that are required in order to have a UPnP device/service or control point usable within the UPnP network. The first step involves IP addressing, where the device acquires an IP address from the DHCP sever or via Auto-IP. The second step, referred to as Discovery, involves control points searching for services or devices/services being advertised into the UPnP network. The third step, referred to as Description, involves the control points fetching the description documents. These first three steps need to occur in this precise order. Other steps, namely the Controlling, Eventing and Presentation steps, do not have such strict requirements.

Unfortunately, there are a number of situations where it is not possible to perform all the steps involved in normal UPnP operations. These situations are often due to limitations caused by the underlying network layer. For example, in a scenario that involves remote access to a UPnP Network, it may be difficult to perform the UPnP discovery step due to long delays caused by the bearer latency on some network segments such as radio access networks like GPRS, or due to a lack of support in tunneling multicast traffic inside VPN tunnels.

In addition to physical limitations, it is also possible that some operational issues may prevent the operation of UPnP discovery. For example, UPnP simple service discovery protocol (SSDP) uses multicast UDP messages to search and advertise devices in the UPnP network. When joining a UPnP network, a device is required to join the standard UPnP multicast group by sending Internet Group Management Protocol (IGMP) messages. Routers are listening to these messages and adding the devices to the multicast group, allowing the respective devices to receive the SSDP messages. UPnP Device architecture specifications note that the “Time to Live” (TTL) of the UPnP multicast message is 4 in UDA v1.0 and 2 in UDA v1.1, thus allowing UPnP messages to pass four hops. However, it possible that not all of the routers on the path are in the same administrative domain and the user does not have rights to join the multicast group on all these routers. Alternatively some routers may not support multicast traffic. Therefore, in more complex networks, there are many cases where multicast traffic might be lost, meaning that the UPnP SSDP cannot work and the whole UPnP concept becomes unusable.

UPnP Device Architecture versions 1.0, 1.0.1 and 1.1 specify that UPnP discovery can be performed using only SSDP. Attempts have been made to perform UPnP discover outside of SSDP. A Device Relay, which is discussed at http://www.intel .com/cd/ids/developer/asmo-na/eng/downloads/upnp/overview/index.htm, has the ability to mirror UPnP devices onto a different network that also has an instance of a running Device Relay. This mechanism effectively bridges two UPnP networks, although material that is out-of-band to UPnP is not bridged. Therefore, all the devices appear to be connected on the same network. The UPnP Relay is started on two different computers, and a WAN interface is used to connect one computer to the other. UPnP Relay automatically creates virtual devices that will mirror all UPnP devices from one network on to the other. Control points on the other network can interact with the virtual devices. However, this type of system requires two special proxies--one on each network--and replicates all of the UPnP traffic from one network to the other and vice versa, leading to UDP multicast “storms.” Additionally, because one virtual device is created for each mirrored device, the memory consumption in the UPnP Relay tool increases with each new device and its complexity. This issue prevents simple devices from playing this role. Currently, this system requires the UPnP Relay to run in a personal computer.

### SUMMARY OF THE INVENTION

The present invention provides for an architecture where Web Syndication mechanisms such as RSS/Atom feeds can be used to discover remote UPnP devices for environments where the standard UPnP discovery mechanism (e.g. SSDP) does not work due to bearer-induced limitations or policy restrictions along the path. The present invention can be used to enable remote access to UPnP Networks.

The present invention allows for the extension of usage of UPnP protocols and services beyond the physical boundaries of the home network. The present invention does not involve the use of multicast messages, which are problematic over uncontrolled networks such as the Internet. The present invention also has a low level of complexity; as SSDP is the only portion of the UPnP stack is altered. Additionally, home UPnP devices do not require changes in order to interact with remote UPnP devices with the present invention. Furthermore, the level of complexity on the remote UPnP device is reduced compared to conventional systems such as the UPnP Relay described above.

The present invention is based on IETF standard protocols (e.g. ATOM), so no standardization overhead in forums other than UPnP is needed. The present invention also only selectively exposes home devices for remote access. The solution of the present invention also has proxy and firewall transversal capabilities, as it uses the HTTP standard port. Furthermore, the Atom SSDP plugin has low implementation overhead, as the required XML parser and HTTP support are already provided by standard UPnP stacks. The Atom XML parser is quite simple. Lastly, with the present invention, there is no need for a standalone device to provide the UPnP Aggregator functionality, as it can be embedded in the UPnP Internet Gateway Device (IGD).

One embodiment of the present invention comprises an electronic device including a processor and a memory unit operatively connected to the processor. The memory unit includes computer code for using SSDP advertisements transmitted within a network to collect network information about local UPnP devices and services that are available within the network; as well as computer code for aggregating the network information into a RSS feed for transmission to at least one remote device outside of the network. Other embodiments comprise modules, computer programs, and methods for performing the same actions and activities.

Another embodiment of the present invention comprises a system for providing communication between devices including at least one local UPnP device located within a network, at least one remote device located outside of the network, and a device aggregator. The device aggregator is configured to use SSDP advertisements transmitted within the network to collect network information about the local UPnP device and services that are available within the network, as well as to aggregate the network information into a RSS feed for transmission to the at least one remote device.

These and other objects, advantages and features of the invention, together with the organization and manner of operation thereof, will become apparent from the following detailed description when taken in conjunction with the accompanying drawings, wherein like elements have like numerals throughout the several drawings described below.

### BRIEF DESCRIPTION OF THE DRAWINGS

FIG. 1 is a representation of the basic network layout and network elements used for the interaction between UPnP devices in separate network segments according to one embodiment of the present invention;

FIG. 2 is a representation of an enhanced UPnP stack with a SSDP RSS/Atom plug-in in accordance with the principles of the present invention;

FIG. 3 is a representation of the protocol stack among a standard UPnP device, a UPnP device aggregator, and an enhanced UPnP device;

FIG. 4 shows the process by which the UPnP device aggregator monitors SSDP traffic from a standard UPnP device and aggregates the monitored information as a RSS/Atom feed.

FIG. 5 shows the process by which the device aggregator collects information about remote devices by accepting Atom POST messages from the devices.

FIG. 6 is a representation of the feed structure for device aggregation according to the principles of the present invention;

FIG. 7 is a representation of the remote search process according to one embodiment of the present invention;

FIG. 8 is a representation of the remote announcement process according to one embodiment of the present invention;

FIG. 9 is a representation of the local search process according to one embodiment of the present invention;

FIG. 10 is a representation of the local announcement process according to one embodiment of the present invention;

FIG. 11 shows a use case scenario where an enhanced UPnP control point is used remotely to access a UPnP network;

FIG. 12 shows the process for remotely using an enhanced UPnP device;

FIG. 13 shows a use case scenario where two UPnP networks are merged according to the principles of the present invention;

FIG. 14 shows a situation where UPnP network devices and device aggregators are also part of a signaling overlay network; and

FIG. 15 is a diagram showing the circuitry which may be found in a UPnP device or device aggregator of the present invention.

### DETAILED DESCRIPTION OF THE PREFERRED EMBODIMENTS

The present invention provides for an architecture where Web Syndication mechanisms such as RSS/Atom feeds can be used to discover remote UPnP devices for environments where the standard UPnP discovery mechanism (e.g. SSDP) does not work due to bearer-induced limitations or policy restrictions along the path. The present invention can be used to enable remote access to UPnP Networks.

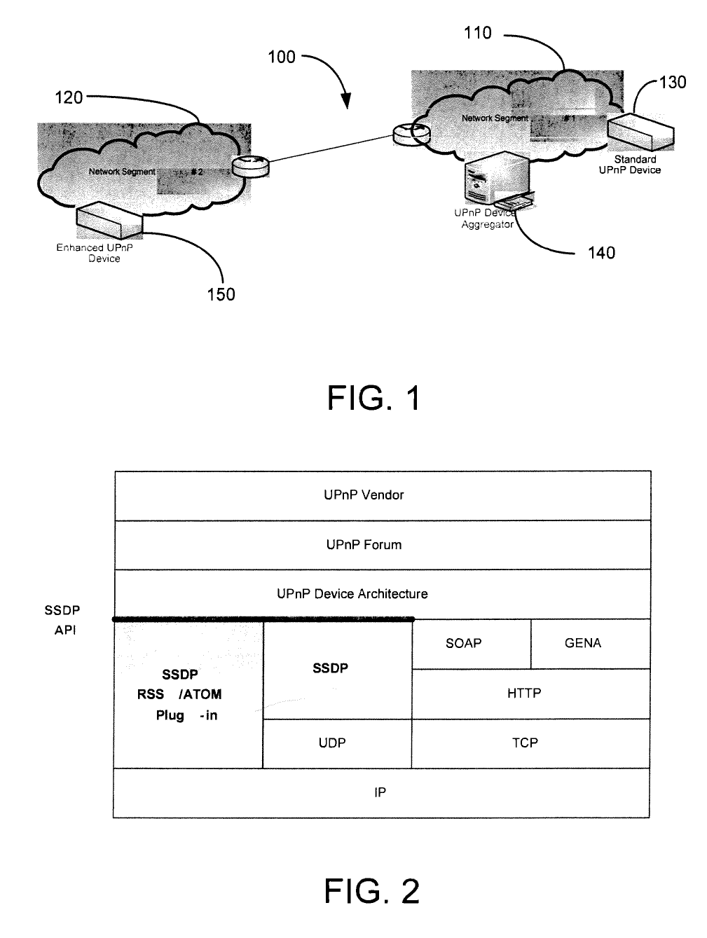

FIG. 1 is a depiction of basic network layout and network elements that are used in the implementation of the present invention. The network topology 100 of FIG. 1 includes a first network segment 110 and a second network segment 120. In the scenario depicted in FIG. 1, it is not possible to have a single multicast group that encompasses both the first network segment 110 and the second network segment 120. In addition to a standard network UPnP device 130 positioned within the first network segment 110, the first network segment 110 also includes a UPnP device aggregator 140. The second network segment 120 includes an enhanced UPnP device 150.

The UPnP device aggregator 140 listens to standard SSDP device advertisements and collects information about UPnP devices and services that are available in the network. The information is then aggregated in RSS/Atom feeds.

The enhanced UPnP device 150 implements functionality that allows out-of-band discovery mechanisms to present information in a format that is compatible with UPnP, e.g., SSDP format.

FIG. 2 describes the protocol stack for the UPnP protocol stack enhanced with SSDP proximity initialization (PI) as an out-of-band discovery protocol. SSDP PI uses the same message payloads as the UPnP SSDP. Instead of using UDP as a transport protocol, however, it uses the location limited channels provided by the PI, including, but not limited to IrDA, RFID, etc.

The operation of an electronic device using out-of-band discovery according to one embodiment of the invention is generally as follows. For service advertisements and as represented, an electronic device that hosts the service, transmits over the location-limited channel a “Service Advertisement” message containing a service advertisement. The payload in the “Service Advertisement” message is the same as for a standard UPnP SSDP message:
NOTIFY*HTTP/1.1
HOST: 239.255.255.250:1900
CACHE-CONTROL: max-age=seconds until advertisement expires
LOCATION: URL for UPnP description for root device
NT: search target
NTS: ssdp:alive
SERVER: OS/version UPnP/1.0 product/version
USN: advertisement UUID

A control point device that hosts the control point receives the “Service Advertisement” message over the location-limited channel and continues the exchange using standard UPnP messages. For example, the control point device can transmit a “Get Description” message, after which the electronic device can respond with a “XML Description” message. UPnP messages can also flow between the electronic device and the control point device.

For a service query, the control point device that hosts the UPnP control point sends a service query message over the location-limited channel. The payload of this message is the same as for a standard UPnP SSDP message:
M-SEARCH*HTTP/1.1
HOST: 239.255.255.250:1900
MAN: “ssdp:discover”
MX: seconds to delay response
ST: search target

The electronic device that hosts the UPnP Service responds also over the location-limited channel with a service response message with the same payload as a standard UPnP SSDP message:
HTTP/1.1 200 OK
CACHE-CONTROL: max-age=seconds until advertisement expires
DATE: when response was generated
EXT:
LOCATION: URL for UPnP description for root device
SERVER: OS/version UPnP/1.0 product/version
ST: search target
USN: advertisement UUID

After the service response message, the devices continue the exchange using standard UPnP messages. For example, the control point device can transmit a “Get Description” message, after which the electronic device can respond with a “XML Description” message. UPnP messages can also flow between the electronic device and the control point device. Computer software code can be used to implement these steps.

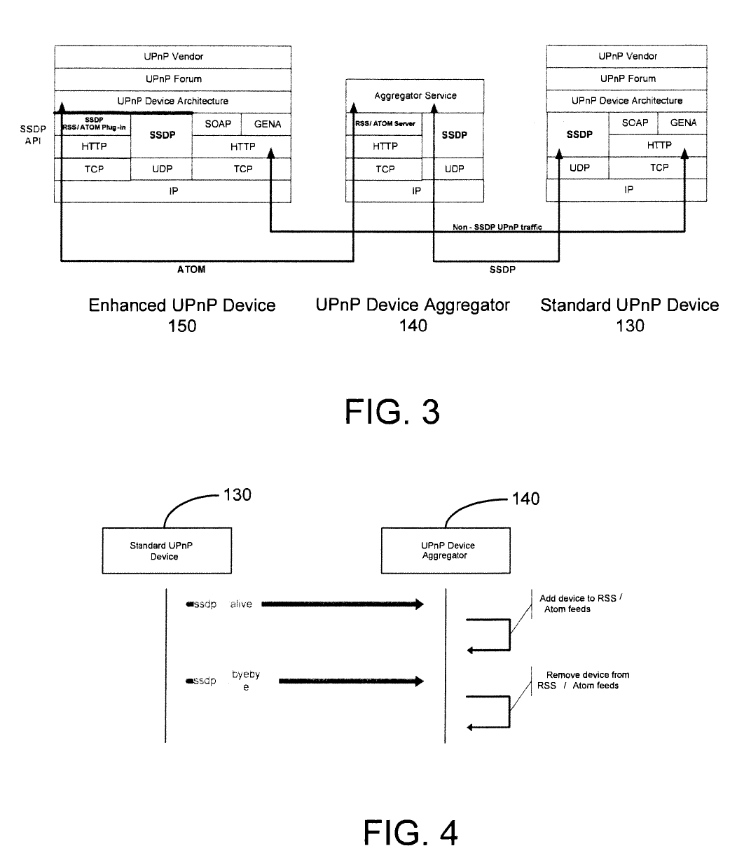

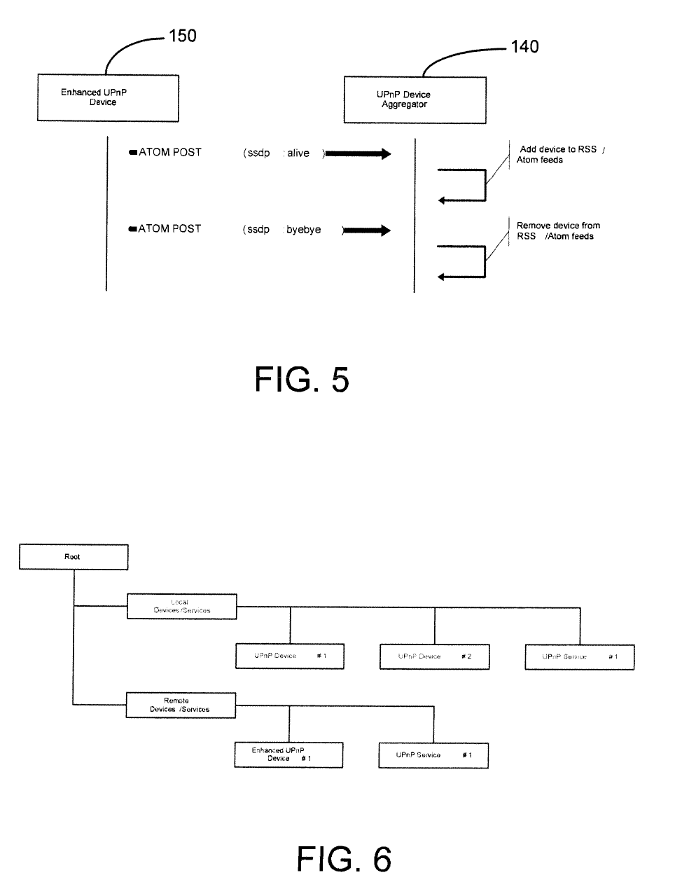

FIG. 3 is a representation of the protocol stack among a standard UPnP device 130, a UPnP device aggregator 140, and an enhanced UPnP device 150 according to the present invention. The primary function of the UPnP device aggregator 140 is to collect information about the UPnP devices that a present in the network by monitoring the UPnP SSDP traffic and to aggregate this information into a RSS/Atom feed. FIG. 4 shows this device aggregation, as the UPnP device aggregator 140 monitors ssdp:alive and ssdp:byebye messages from the standard UPnP device 130, and adds the relevant information to or removes the information from the RSS/Atom feeds, respectively. The UPnP device aggregator 140 also collects information about remote devices such as enhanced UPnP devices 150 by accepting Atom POST messages from the devices. This process is depicted in FIG. 5. As shown in FIG. 5, when an Atom POST (ssdp:alive) message is transmitted from the enhanced UPnP device 150, the UPnP device aggregator 140 adds the device to the RSS/Atom feed within the network. The device is removed when the UPnP device aggregator 140 receives an Atom POST (ssdp:byebye) message from the enhanced UPnP device 150.

The RSS/Atom feed created by the UPnP device aggregator 140 keeps track of how the particular device information was acquired. Devices that were discovered through SSDP announcements are kept in a local branch, while devices that were discovered from Atom feeds are kept in a remote branch. The feed structure for such device aggregation is depicted in FIG. 6.

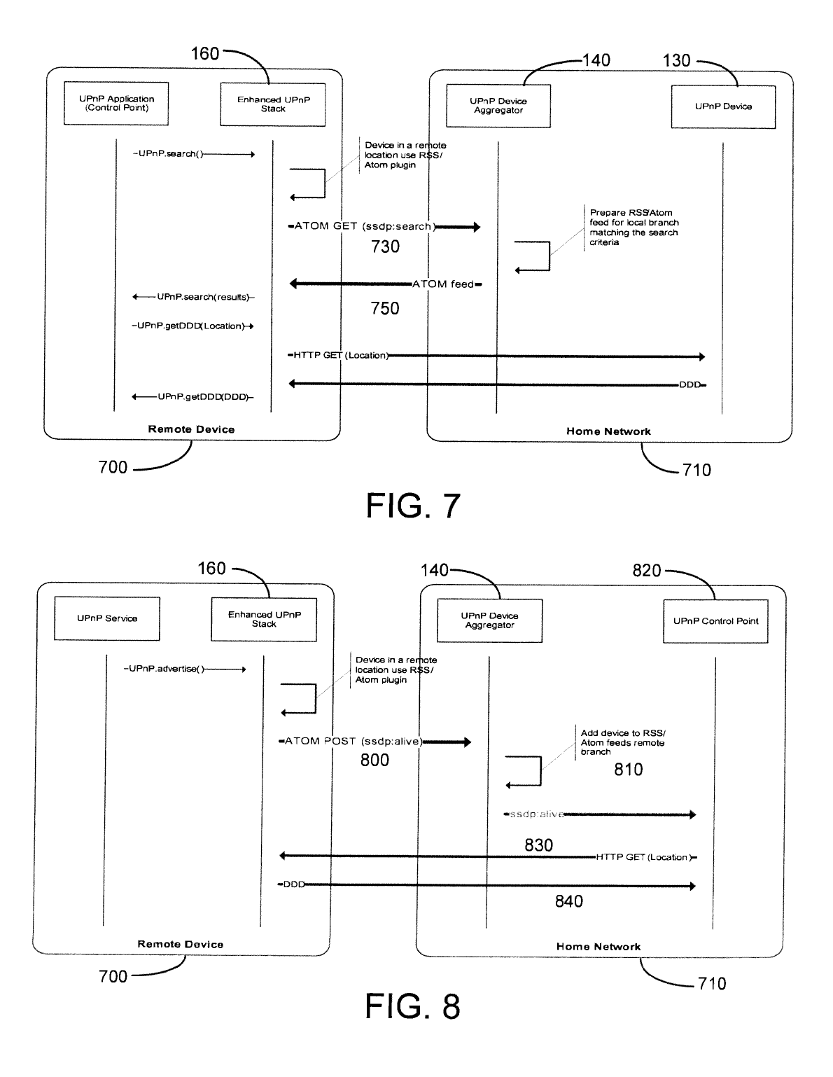

FIG. 7 is a representation of the remote search process according to one embodiment of the present invention for a remote device 700 and a home network 710. As shown in FIG. 7, the enhanced UPnP device architecture stack 160 from the remote device (i.e., the enhanced UPnP device 150) detects that it is in a remote location using bearer characteristics hints (e.g., GPRS/WCDMA, WLAN hotspot) or through the existence of secure remote connections to home and starts using the Atom plugin. The use of the Atom plugin is represented at 720 in FIG. 7. In order to search for a service device, the remote device fetches the Atom feed from the home UPnP device aggregator 140. This is accomplished by the enhanced UPnP stack 160 transmitting an Atom GET (ssdp:search) message 730. the UPnP device aggregator 140 then prepares the RSS/Atom feed for the local branch matching the search criteria at 740, after which the Atom feed is made available to the enhanced UPnP stack 160 at 750. The enhanced UPnP stack 160 then parses the feed, extracts the location URI and downloads the device description document directly from the UPnP device that is located in the home network. The rest of the UPnP communication can then occur directly between the remote device and the home network device.

FIG. 8 is a representation of the remote announcement process according to one embodiment of the present invention. When the remote device 700 wants to advertise a service, the enhanced UPnP stack 160 updates the home UPnP device aggregator 140 in the home network 710 with an Atom POST message containing the ssdp:alive information. This is represented at 800 in FIG. 8. When the UPnP device aggregator 140 receives the update, it sends a UPnP ssdp:alive message within the home network with the information that has been received from the remote device. This is represented at 810 in FIG. 8. Once the UPnP ssdp:alive message has been received by any UPnP control points 820 within the home network 710, they are capable of directly communicating with the remote device 700, as represented at step 830 and 840.

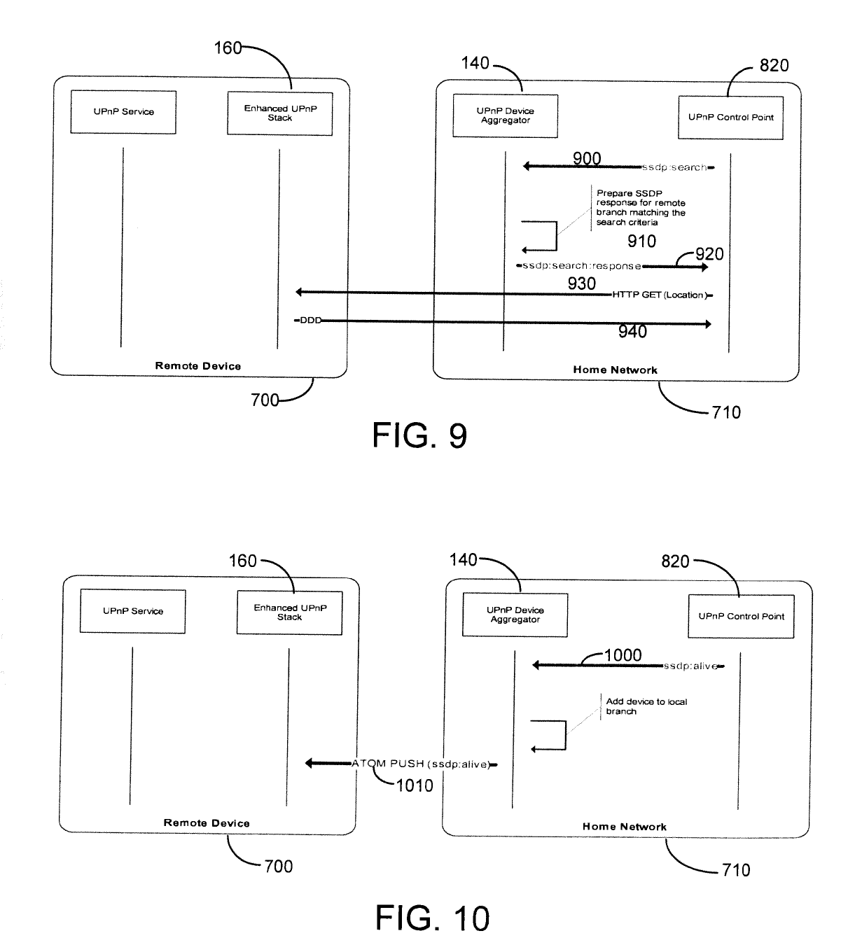

FIG. 9 is a representation of the local search process according to one embodiment of the present invention. In FIG. 9, a local device (the UPnP control point 820) is looking for services of interest by transmitting a ssdp:search multicast message at 900. The UPnP device aggregator 140 receives this message, prepares a SSDP response for the remote branch matching the search criteria 910, and transmits a ssdp:search:response message 920 back to the UPnP control point 820. As a result of this process, the remote device 700 is “UPnP” visible to the UPnP control point 820 within the home network 710. After receiving the ssdp:search:response message from the UPnP device aggregator 140, the UPnP control point 820 can directly fetch the remote device description from the remote device 700, as represented at 930 and 940.

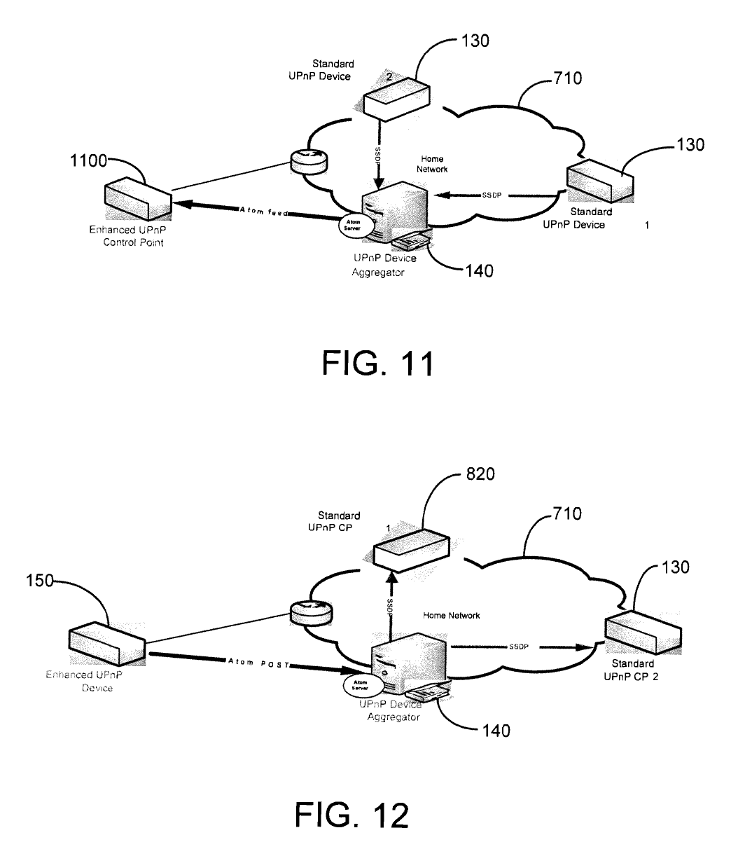

FIG. 10 is a representation of the local announcement process according to one embodiment of the present invention. When a new local device joins the home network 710, it transmits a ssdp:alive message 1000 on the home network 710. the UPnP device aggregator 140 listens and, once it receives the ssdp:alive message 1000, pushes the device information to the remote device 700 using an Atom PUSH (ssdp:alive) message 1010. FIG. 11 shows a use case scenario where an enhanced UPnP control point 1100 is used remotely, and FIG. 12 shows where an enhanced UPnP device 150 is used remotely..

In addition to the above, the present invention can be implemented in a variety of different ways. For example, the UPnP device aggregator 140 as discussed above can be implemented in different manners. For example, the UPnP device aggregator 140 can be implemented as part of a UPnP Internet gateway device. the UPnP device aggregator 140 can also be implemented as a stand-along UPnP device, where the device's only purpose involves aggregation. The UPnP device aggregator can also be formed as part of any other UPnP device as necessary or desired.

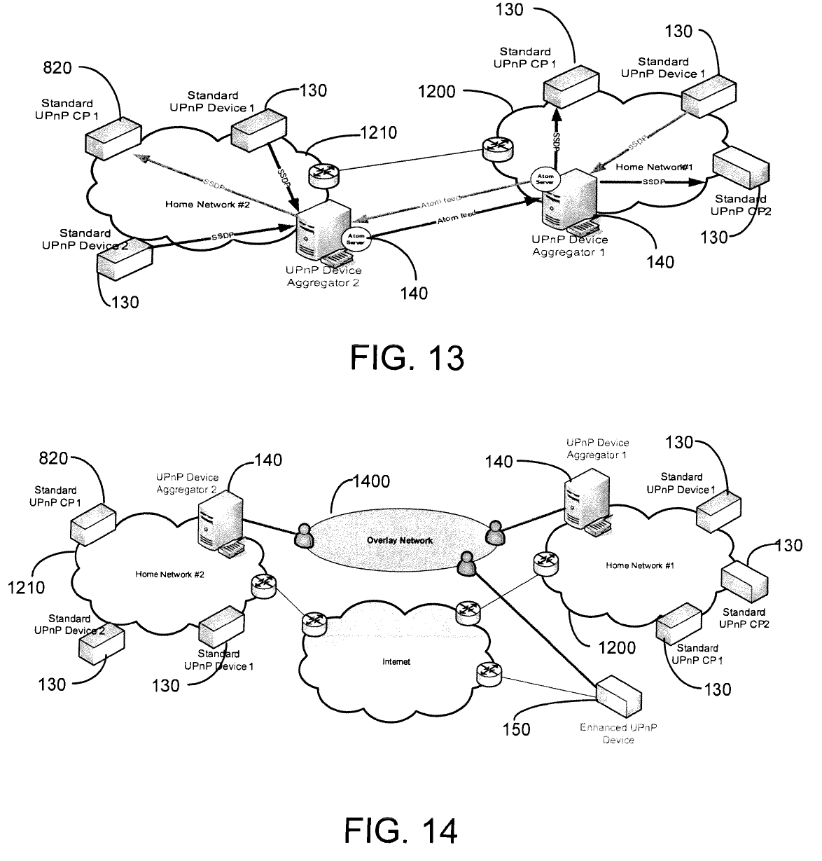

FIG. 13 shows a scenario where a first UPnP home network 1200 and a second UPnP home network 1210 are merged. In this network scenario, all of the UPnP devices except for the UPnP device aggregators 140 within each of the home networks are standard UPnP devices with no enhancements. In this situation, the two UPnP device aggregators 140 are syndicating each other's local branch feeds. At the end of the process, the local branches of each UPnP device aggregator 140 appear as the remote branch on the other device aggregator 140 and vice versa.

In addition, a number of different enhancements can be included with the present invention. For example and in one embodiment of the present invention, the UPnP device aggregator 140 has the ability to restrict the visibility of the local branch based on the identify of the remote device obtained during the authentication process. In order to expose a local device for remote access, explicit authorization needs to be granted to the remote device during the remote access setup procedure. In other words, the user needs to select which devices are visible remotely for each remote device which has access to the home network.

In another embodiment of the present invention and as depicted in FIG. 14, active elements which are involved in the remote access scenarios (e.g., remote UPnP devices and UPnP device aggregators) can be part of an overlay signaling network 1400 such as Skype, Google Talk, Yahoo Messenger, xConnect, etc. The signaling overlay network is used to discover the network elements and to establish secure channels between these elements.

The following is an example of how an ssdp:alive message is converted into an Atom POST message in accordance with the present invention. The following is a depiction of an original ssdp:alive message:

NOTIFY * HTTP/1.1
HOST: 239.255.255.250:1900
CACHE-CONTROL: max-age = seconds until advertisement expires
LOCATION: URL for UPnP description for root device
NT: notification type
NTS: ssdp:alive
SERVER: OS/version UPnP/1.1 product/version
USN: composite identifier for the advertisement
BOOTID.UPNP.ORG: number increased each time device sends an
initial announce
CONFIGID.UPNP.ORG: number used for caching description
information
MAXVERSION.UPNP.ORG: number identifies highest version of
announced device/service
SEARCHPORT.UPNP.ORG: number identifies port on which device
responds to unicast M-SEARCH

The following is the converted Atom POST (ssdp:alive) message:

POST* HTTP/1.1
Content-Type: application/atom+xml
<?xml version=“1.0” encoding=“utf-8”?>
<entry xmlns=“http://purl.org/atom/ns#”>

<title>Device/Service name</title>

<created>Date/Time of creation</created>
<content type=“text/plain”>

The following is an original ssdp:response message:

HTTP/1.1 200 OK
CACHE-CONTROL: max-age = seconds until advertisement expires
DATE: when response was generated
EXT:
LOCATION: URL for UPnP description for root device
SERVER: OS/version UPnP/1.1 product/version
ST: search target
USN: composite identifier for the advertisement
BOOTID.UPNP.ORG: number increased each time device sends an
initial announce
CONFIGID.UPNP.ORG: number used for caching description
information
MAXVERSION.UPNP.ORG: number identifies highest version of
announced device/service

The following is a converted Atom GET feed (ssdp:response message):

HTTP/1.1 200 OK
Content-Type: application/atom+xml
<?xml version=“1.0” encoding=“utf-8”?>
<feed xmlns=“http://purl.org/atom/ns#”>
<title>Aggregator identifier</title>
<link rel=“service.post” type=“application/atom+xml”

href=“URL for posting new announcements to aggregator”/>

<modified>Date/Time that feed was last modified</modified>
<entry>

<title>Device/Service name </title>
<link

rel=“service.edit” type=“application/atom+xml”
href=“URL for updating specific entry in aggregator”/>

<id> composite identifier for the advertisement </id>
<issued>Date/Time of original announcement</issued>
<modified>Date/Time that announcement was last
modified</modified>
<content type=“text/plain”>

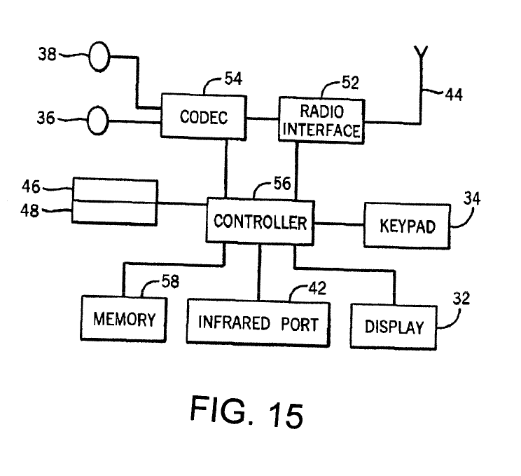

FIG. 15 shows circuitry for one representative electronic device which can be used in conjunction with the present invention. For example, this circuitry can be included in a device aggregator, a standard UPnP device, or an enhanced UPnP device. It should be understood, however, that the present invention is not intended to be limited to one particular type of electronic device. It should also be noted that various electronic devices may not include all of the components shown in FIG. 15. The electronic device of FIG. 15 includes a display 32 in the form of a liquid crystal display, a keypad 34, a microphone 36, an ear-piece 38, a battery 40, an infrared port 42, an antenna 44, a smart card 46 in the form of a UICC according to one embodiment of the invention, a card reader 48, radio interface circuitry 52, coded circuitry 54, a controller 56, such as a processor, and a memory 58. Individual circuits and elements are all of a type well known in the art, for example in the Nokia range of mobile telephones.

The present invention is described in the general context of method steps, which may be implemented in one embodiment by a program product including computer-executable instructions, such as program code, executed by computers in networked environments.

Generally, program modules include routines, programs, objects, components, data structures, etc. that perform particular tasks or implement particular abstract data types. Computer-executable instructions, associated data structures, and program modules represent examples of program code for executing steps of the methods disclosed herein. The particular sequence of such executable instructions or associated data structures represent examples of corresponding acts for implementing the functions described in such steps.

Software and web implementations of the present invention could be accomplished with standard programming techniques with rule based logic and other logic to accomplish the various database searching steps, correlation steps, comparison steps and decision steps. It should also be noted that the words “component” and “module” as used herein, and in the claims, is intended to encompass implementations using one or more lines of software code, and/or hardware implementations, and/or equipment for receiving manual inputs.

The foregoing description of embodiments of the present invention have been presented for purposes of illustration and description. It is not intended to be exhaustive or to limit the present invention to the precise form disclosed, and modifications and variations are possible in light of the above teachings or may be acquired from practice of the present invention. The embodiments were chosen and described in order to explain the principles of the present invention and its practical application to enable one skilled in the art to utilize the present invention in various embodiments and with various modifications as are suited to the particular use contemplated.

What is claimed is:

1. An electronic device, comprising:
a processor; and
a memory unit operatively connected to the processor and including:
computer code for using SSDP advertisements transmitted within a network to collect network information about local UPnP devices and services that are available within the network; and
computer code for aggregating the network information into a RSS feed for transmission to at least one remote device outside of the network.

2. The electronic device of claim 1, wherein the memory unit includes computer code for collecting remote information about the at least one remote device by accepting Atom POST messages from the at least one remote device.

3. The electronic device of claim 2, wherein the memory unit includes:
computer code for maintaining in a local branch information about devices discovered from SSDP announcements; and
computer code for maintaining in a remote branch information about devices discovered from Atom feeds and messages.

4. The electronic device of claim 3, wherein the memory unit includes computer code for selectively restricting the visibility of the local branch based upon the identity of the at least one remote device.

5. The electronic device of claim 2, wherein the memory unit includes computer code for, upon receiving an Atom POST message from the at least one remote device, transmitting a SSDP message within the network indicative of the content of the Atom Post message.

6. The electronic device of claim 1, wherein the memory unit includes:
computer code for receiving an ssdp:search request from a local UPnP device within the network; and
computer code for transmitting to the local UPnP device, on behalf of the at least one remote device, information response to the ssdp:search request.

7. The electronic device of claim 1, wherein the memory unit includes:
computer code for receiving a ssdp:alive message indicating that a new local UPnP device has entered the network; and
computer code for using an Atom PUSH message to transmit information concerning the new local UPnP device to the at least one remote device.

8. The electronic device of claim 1, wherein the memory unit includes computer code for using an overlay signaling network to identify the at least one remote device.

9. The electronic device of claim 1, wherein the memory unit includes computer code for using an overlay signaling network to establish connections between the at least one remote device and local UPnP devices.

10. The electronic device of claim 1, wherein the electronic device comprises a stand alone UPnP device.

11. The electronic device of claim 1, wherein the electronic device is part of a UPnP Internet gateway device.

12. A module for use with an electronic device, comprising:
a memory unit;
a processor operatively connected to the memory unit; and
a data communication link for enabling communication within a network;
wherein the memory unit includes:
computer code for using SSDP advertisements transmitted within a network to collect network information about local UPnP devices and services that are available within the network; and
computer code for aggregating the network information into a Atom feed for transmission to at least one remote device outside of the network.

13. The module of claim 12, wherein the memory unit includes computer code for collecting remote information about the at least one remote device by accepting Atom POST messages from the at least one remote device.

14. The module of claim 13, wherein the memory unit includes computer code for, upon receiving an Atom POST message from the at least one remote device, transmitting a SSDP message within the network indicative of the content of the Atom Post message.

15. The module of claim 12, wherein the memory unit includes:
computer code for receiving an ssdp:search request from a local UPnP device within the network; and
computer code for transmitting to the local UPnP device, on behalf of the at least one remote device, information response to the ssdp:search request.

16. The module of claim 12, wherein the memory unit includes:
computer code for receiving a ssdp:alive message indicating that a new local UPnP device has entered the network; and
computer code for using an Atom PUSH message to transmit information concerning the new local UPnP device to the at least one remote device.

17. The module of claim 12, wherein the memory unit includes computer code for using an overlay signaling network to identify the at least one remote device.

18. The module of claim 12, wherein the memory unit includes computer code for using an overlay signaling network to establish connections between the at least one remote device and local UPnP devices.

19. A system for providing communication between devices, comprising:
at least one local UPnP device located within a network;
at least one remote device located outside of the network; and
a device aggregator including:
computer code for using SSDP advertisements transmitted within the network to collect network information about the local UPnP device and services that are available within the network; and
computer code for aggregating the network information into a RSS feed for transmission to the at least one remote device.

20. The system of claim 19, wherein the device aggregator includes computer code for collecting remote information about the at least one remote device by accepting Atom POST messages from the at least one remote device.

21. The system of claim 20, wherein the device aggregator includes computer code for, upon receiving an Atom POST message from the at least one remote device, transmitting a SSDP message within the network indicative of the content of the Atom Post message.

22. The system of claim 19, wherein the device aggregator includes:
computer code for receiving an ssdp:search request from a local UPnP device within the network; and
computer code for transmitting to the local UPnP device, on behalf of the at least one remote device, information response to the ssdp:search request.

23. The system of claim 19, wherein the device aggregator includes:
computer code for receiving a ssdp:alive message indicating that a new local UPnP device has entered the network; and
computer code for using an Atom PUSH message to transmit information concerning the new local UPnP device to the at least one remote device.

24. The system of claim 19, wherein the device aggregator includes computer code for using an overlay signaling network to identify the at least one remote device.

25. The system of claim 19, wherein the device aggregator includes computer code for using an overlay signaling network to establish connections between the at least one remote device and local UPnP devices.

26. A computer program product for enabling communication between devices inside and outside of a network, comprising:
computer code for using SSDP advertisements transmitted within a network to collect network information about local UPnP devices and services that are available within the network; and
computer code for aggregating the network information into a RSS feed for transmission to at least one remote device outside of the network.

27. The computer program product of claim 26, further comprising computer code for collecting remote information about the at least one remote device by accepting Atom POST messages from the at least one remote device.

28. The computer program product of claim 27, further comprising computer code for, upon receiving an Atom POST message from the at least one remote device, transmitting a SSDP message within the network indicative of the content of the Atom Post message.

29. The computer program product of claim 26, further comprising:
computer code for receiving an ssdp:search request from a local UPnP device within the network; and
computer code for transmitting to the local UPnP device, on behalf of the at least one remote device, information response to the SSDP search request.

30. The computer program product of claim 26, further comprising:
computer code for receiving a ssdp:alive message indicating that a new local UPnP device has entered the network; and
computer code for using an Atom PUSH mechanism to transmit information concerning the new local UPnP device to the at least one remote device.

31. A method of enabling communication between devices inside and outside of a network, comprising:
using SSDP advertisements transmitted within a network to collect network information about local UPnP devices and services that are available within the network; and
aggregating the network information into a RSS feed for transmission to at least one remote device outside of the network.

32. The method of claim 31, further comprising collecting remote information about the at least one remote device by accepting Atom POST messages from the at least one remote device.

33. The method of claim 32, further comprising, upon receiving an Atom POST message from the at least one remote device, transmitting a SSDP message within the network indicative of the content of the Atom Post message.

34. The method of claim 31, further comprising:
receiving an ssdp:search request from a local UPnP device within the network; and
transmitting to the local UPnP device, on behalf of the at least one remote device, information response to the ssdp:search request.

35. The method of claim 31, further comprising:
receiving a ssdp:alive message indicating that a new local UPnP device has entered the network; and
using an Atom PUSH message to transmit information concerning the new local UPnP device to the at least one remote device.
